(19) United States
(12) Patent Application Publication
(10) Pub. No.: US 2026/0197403 A1
(43) Pub. Date: Jul. 9, 2026

(54) CALL CONTROL METHOD, NON-TRANSITORY COMPUTER-READABLE RECORDING MEDIUM, AND CALL CONTROL SYSTEM

(71) Applicant: JIFFCY INC., Tokyo (JP)

(72) Inventor: Masaki Nishimura, Tokyo (JP)

(73) Assignee: JIFFCY INC., Tokyo (JP)

(21) Appl. No.: 19/437,439

(22) Filed: Dec. 31, 2025

(30) Foreign Application Priority Data
Jan. 7, 2025 (JP) 2025-002213

(51) Int. Cl. H04M 3/56; H04M 3/42

(52) U.S. Cl. CPC H04M 3/56; H04M 3/42042; H04M 2203/5081

(57) ABSTRACT

Provided is a call control method executed by a computer of an operation terminal to execute a process. The process includes generating an identifier of a group call, notifying a management server of the group call of the identifier, transmitting the identifier and a first call of a first conversation partner to a first terminal of the first conversation partner belonging to the plurality of conversation partners, displaying a call screen of the group call on the operation terminal and transmitting the identifier and a second call of a second conversation partner to a second terminal of the second conversation partner belonging to the plurality of conversation partners when participation of the first conversation partner in the group call is notified from the management server, and updating the call screen when participation of the second conversation partner in the group call is notified from the management server.

### CROSS-REFERENCE TO RELATED APPLICATION

This application is based upon and claims the benefit of priority of Japanese Patent Application No. 2025-002213 filed on January 7, 2025, the entire contents of which are incorporated herein by reference.

### FIELD

A certain aspect of the present embodiments relates to a call control method, a non-transitory computer-readable recording medium, and a call control system.

### BACKGROUND

There has been known a technique for performing a call while avoiding vocalization while improving real-time performance (for example, see Japanese Patent No. 7397523). In addition, there has been known a technique for easily designating a game opponent by linking an instant messenger that supports a conversation between users and a game when a match-up type game is executed between terminals. For example, when a user operates an opponent designation button displayed on a startup screen immediately after the game application is started, a screen for designating a user to be invited as an opponent is displayed (see, for example, Japanese Patent Application Publication No. 2015-150270).

### SUMMARY

According to a first aspect of the present disclosure, there is provided a call control method executed by a computer of an operation terminal to execute a process. The process includes: generating an identifier of a group call when the operation terminal of a user who has a conversation with a plurality of conversation partners is instructed to generate a group in which the plurality of conversation partners are designated; notifying a management server of the group call of the identifier when start of the group call is instructed; transmitting the identifier and a first call of a first conversation partner to a first terminal of the first conversation partner belonging to the plurality of conversation partners; displaying a call screen of the group call on the operation terminal and transmitting the identifier and a second call of a second conversation partner to a second terminal of the second conversation partner belonging to the plurality of conversation partners when participation of the first conversation partner in the group call by a response operation of the first conversation partner to a first incoming call screen displayed on the first terminal based on incoming call of the identifier and the first call is notified from the management server; and updating the call screen when participation of the second conversation partner in the group call by a response operation of the second conversation partner to a second incoming call screen displayed on the second terminal based on incoming call of the identifier and the second call is notified from the management server.

In the above process, the process further may include: updating the call screen and transmitting the identifier and a third call of a third conversation partner to a third terminal of a third conversation partner belonging to the plurality of conversation partners; and further updating the call screen when participation of the third conversation partner in the group call by a response operation of the third conversation partner to a third incoming call screen displayed on the third terminal based on incoming call of the identifier and the third call is notified from the management server.

In the above process, the identifier and the second call may be transmitted to the second terminal when elapse of a first time limit for limiting a response operation of the first conversation partner is notified from the first terminal, and the identifier and the third call may be transmitted to the third terminal when elapse of a second time limit for limiting a response operation of the second conversation partner is notified from the second terminal.

In the above process, the call screen may include a plurality of display regions divided for each conversation partner of the plurality of conversation partners, and the process further may include changing a color of a display region corresponding to any one of the conversation partners when the any one of the conversation partners participating in the group call leaves the group call.

In the above process, the group call may be a call by characters between the user and the plurality of conversation partners.

In the above process, the operation terminal may selectively use any one of a first call scheme for making a call by characters and a second call scheme for making a call by voice, during the group call.

According to a second aspect of the present disclosure, there is provided a non-transitory computer-readable recording medium having stored therein a program for causing a computer to execute a process. The process includes: generating an identifier of a group call when an operation terminal of a user who has a conversation with a plurality of conversation partners is instructed to generate a group in which the plurality of conversation partners are designated; notifying a management server of the group call of the identifier when start of the group call is instructed; transmitting the identifier and a first call of a first conversation partner to a first terminal of the first conversation partner belonging to the plurality of conversation partners; displaying a call screen of the group call on the operation terminal and transmitting the identifier and a second call of a second conversation partner to a second terminal of the second conversation partner belonging to the plurality of conversation partners when participation of the first conversation partner in the group call by a response operation of the first conversation partner to a first incoming call screen displayed on the first terminal based on incoming call of the identifier and the first call is notified from the management server; and updating the call screen when participation of the second conversation partner in the group call by a response operation of the second conversation partner to a second incoming call screen displayed on the second terminal based on incoming call of the identifier and the second call is notified from the management server.

According to a third aspect of the present disclosure, there is provided a call control system including: a receiver that receives an identifier of a group call from an operation terminal of a user who has a conversation with a plurality of conversation partners when the identifier is notified by an instruction of start of the group call, the identifier being generated by an instruction to the operation terminal of generation of a group in which the plurality of conversation partners are designated; a generator that generates information for managing the group call based on the identifier; a first notifier that notifies the operation terminal of participation of a first conversation partner in the group call when the participation of the first conversation partner in the group call is notified from a first terminal of the first conversation partner based on a first incoming call of the first terminal of the first conversation partner to the identifier transmitted from the operation terminal with display of a call screen of the group call in the operation terminal and a first call of the first conversation partner belonging to the plurality of conversation partners, and a response operation of the first conversation partner on a first incoming call screen displayed based on the first incoming call; and a second notifier that notifies the operation terminal of participation of a second conversation partner in the group call when the participation of the second conversation partner in the group call is notified from a second terminal of the second conversation partner based on a second incoming call of the second terminal of the second conversation partner to the identifier transmitted from the operation terminal with update of the call screen in the operation terminal and a second call of the second conversation partner belonging to the plurality of conversation partners, and a response operation of the second conversation partner on a second incoming call screen displayed based on the second incoming call.

### BRIEF DESCRIPTION OF THE DRAWINGS

FIG. 1 is a diagram illustrating an example of a group call system.

FIG. 2 is an example of a hardware configuration of a mobile terminal.

FIG. 3 is an example of a functional configuration of the mobile terminal.

FIG. 4A illustrates an example of user information.

FIG. 4B illustrates an example of talk room identification information.

FIG. 5 is a diagram illustrating an example of a hardware configuration of a call control system;

FIG. 6 is a diagram illustrating an example of a functional configuration of the call control system.

FIG. 7 illustrates an example of call state information.

FIG. 8 illustrates an example of character information.

FIG. 9 is a diagram illustrating an example of a processing sequence of the group call system.

FIG. 10 is a diagram illustrating another example of a processing sequence of the group call system.

FIG. 11 illustrates an example of a group call start screen.

FIG. 12A illustrates an example of an outgoing call screen.

FIG. 12B illustrates an example of an incoming call screen.

FIG. 13 illustrates an example of a call screen of a group call.

FIG. 14 illustrates another example of a call screen of a group call.

### DESCRIPTION OF EMBODIMENTS

In the case where a group call with a plurality of conversation partners is performed between a plurality of terminals, even when a user operates his/her own terminal to call a plurality of conversation partners, some conversation partners may not notice the call and may not respond to the call. For example, if the first conversation partner among the plurality of conversation partners does not notice the call, it takes time until a call with the subsequent conversation partner is started, and a smooth group call is hindered.

Therefore, in one aspect, it is an object to provide a call control method, a non-transitory computer-readable recording medium, and a call control system that smoothly start the group call in which the call is made with the plurality of conversation partners.

Hereinafter, embodiments of the present disclosure will be described with reference to the drawings.

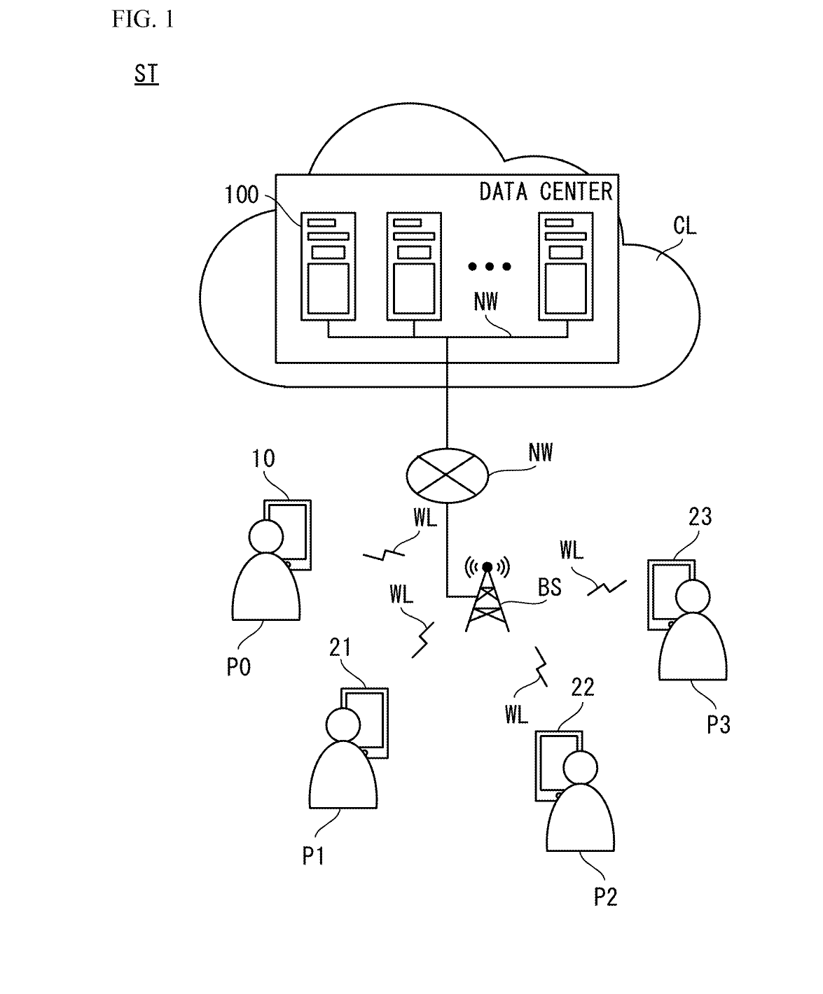

As illustrated in FIG. 1, a group call system ST includes mobile terminals 10, 21, 22, 23 and a call control system 100. The call control system 100 is implemented in a data center DC on a cloud (specifically, a public cloud) CL. Although the call control system 100 is illustrated as a single management server in FIG. 1, various functions of the call control system 100 may be distributed to a plurality of management servers according to the functions, and the plurality of management servers may communicate with each other to cooperate with each other.

The call control system 100 communicates with the mobile terminals 10, 21, 22, and 23. The mobile terminal 10 is a device carried by a user P0 who uses the call control system 100. The mobile terminal 21 is a device carried by a user P1 who uses the call control system 100. The mobile terminal 22 is a device carried by a user P2 who uses the call control system 100. The mobile terminal 23 is a device carried by a user P3 who uses the call control system 100.

The mobile terminal 10 is an example of an operation terminal. The mobile terminal 21 is an example of a first terminal. The mobile terminal 21 is an example of a second terminal. The mobile terminal 23 is an example of a third terminal. The user P0 is a caller of the group call, and is an example of a user. The users P1, P2, and P3 are examples of a plurality of conversation partners. In particular, the user P1 is an example of a first conversation partner, the user P2 is an example of a second conversation partner, and the user P3 is an example of a third conversation partner. Although smartphones are illustrated as examples of the mobile terminals 10, 21, 22, and 23 in FIG. 1, each of the mobile terminals 10, 21, 22, 23 may be a terminal having at least portability and a communication function, such as a tablet terminal, a smartwatch, a virtual reality (VR) device, a game terminal, or a wearable device.

The call control system 100 communicates with the mobile terminals 10, 21, 22, and 23 via a wired communication network NW, a mobile base station BS, and a wireless communication network WL. Examples of the wired communication network NW include communication networks such as Internet and a local area network (LAN). The wireless communication network WL may be a communication network using, for example, Long Term Evolution (LTE).

For example, when the mobile terminals 10, 21, 22, and 23 are included in a communicable area of the mobile base station BS, the call control system 100 communicates with the mobile terminals 10, 21, 22, and 23 via the wired communication network NW, the mobile base station BS, and the wireless communication network WL. A call control application that communicates with the call control system 100 is installed in each of the mobile terminals 10, 21, 22, and 23. The call control application is an application program (or application software) that realizes a call by characters or voice between the users P0, P1, P2, and P3 in cooperation with the call control system 100.

In this embodiment, the users P1, P2, and P3 represent acquaintances of the user P0. Each of the acquaintances includes, for example, a friend, a family member, a relative, a coworker, a superior, a subordinate, and the like, but is not particularly limited thereto as long as the acquaintance is a person having some relationship with the user P0. When the user P0 operates the mobile terminal 10 to activate the call control application, the mobile terminal 10 displays a start screen of the group call.

As will be described in detail later, the start screen includes a group call button. The group call button can individually call each of the users P1, P2, and P3 by displaying the incoming call screen. When the mobile terminal 10 is instructed to generate a group by designating the users P1, P2, and P3, the mobile terminal 10 generates an identifier of the group call. When the mobile terminal 10 detects the start of the group call by pressing the group call button, the mobile terminal 10 notifies the call control system 100 of the identifier of the group call. After notifying the identifier of the group call, the mobile terminal 10 switches the start screen of the group call to the outgoing call screen, and individually transmits the identifier and the call signal to each of the mobile terminals 21, 22, and 23. When each of the mobile terminals 21, 22, and 23 detects the identifier and the incoming call of the call signal, each of the mobile terminals 21, 22, and 23 displays an incoming call screen. Thus, the users P1, P2, and P3 can perform a response operation for responding to the incoming call or a rejection operation for rejecting the response to the incoming call on the incoming call screen.

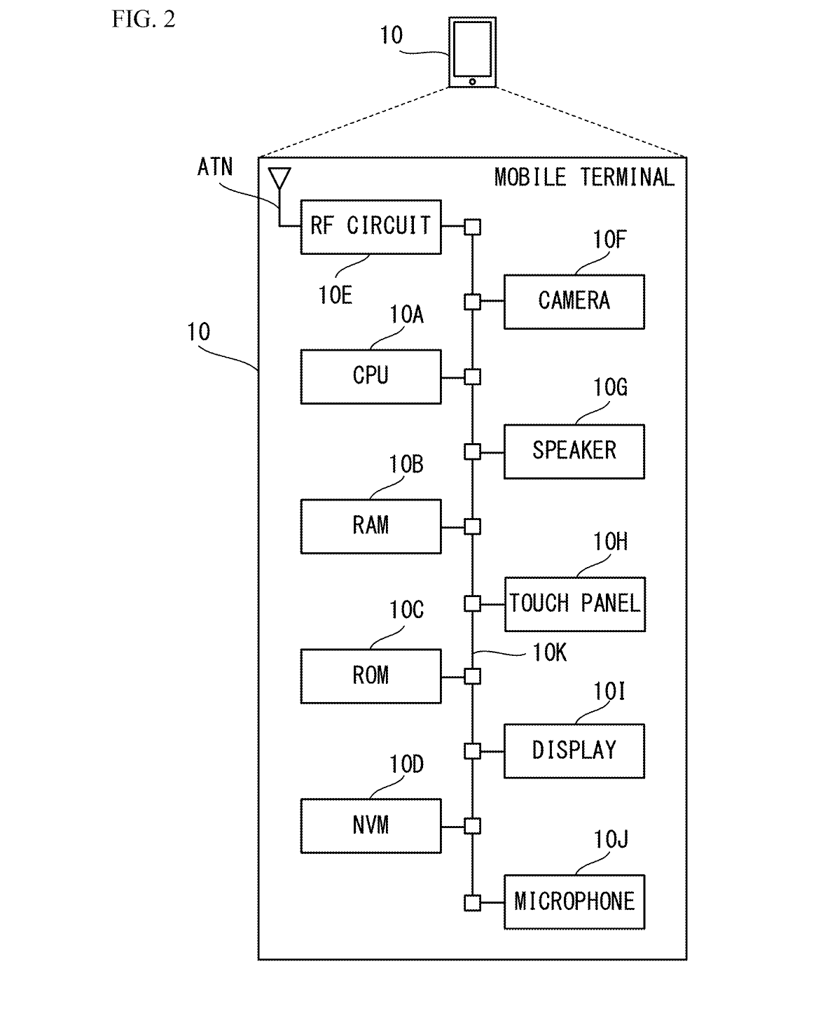

Next, a hardware configuration of the mobile terminal 10 will be described with reference to FIG. 2. The hardware configuration of the mobile terminals 21, 22, and 23 described above is basically the same as the hardware configuration of the mobile terminal 10, and thus detailed description thereof will be omitted.

The mobile terminal 10 includes a central processing unit (CPU) 10A as a processor, a random access memory (RAM) 10B, a read only memory (ROM) 10C, and a non-volatile memory (NVM) 10D as memories, and a radio frequency (RF) circuit 10E. An antenna ATN is connected to the RF circuit 10E. A CPU that realizes a communication function may be used instead of the RF circuit 10E.

The mobile terminal 10 includes a camera 10F, a speaker 10G, a touch panel 10H, a display 10I, and a microphone 10J. The components from the CPU 10A to the microphone 10J are connected to each other by an internal bus 10K. The computer is realized by cooperation of at least the CPU 10A and the RAM 10B.

A call control program stored in the ROM 10C or the NVM 10D is stored in the above-described RAM 10B by the CPU 10A. When the CPU 10A executes the stored call control program, the CPU 10A realizes various functions described later and executes a series of processes. The call control program may be a program according to a processing sequence diagram described later.

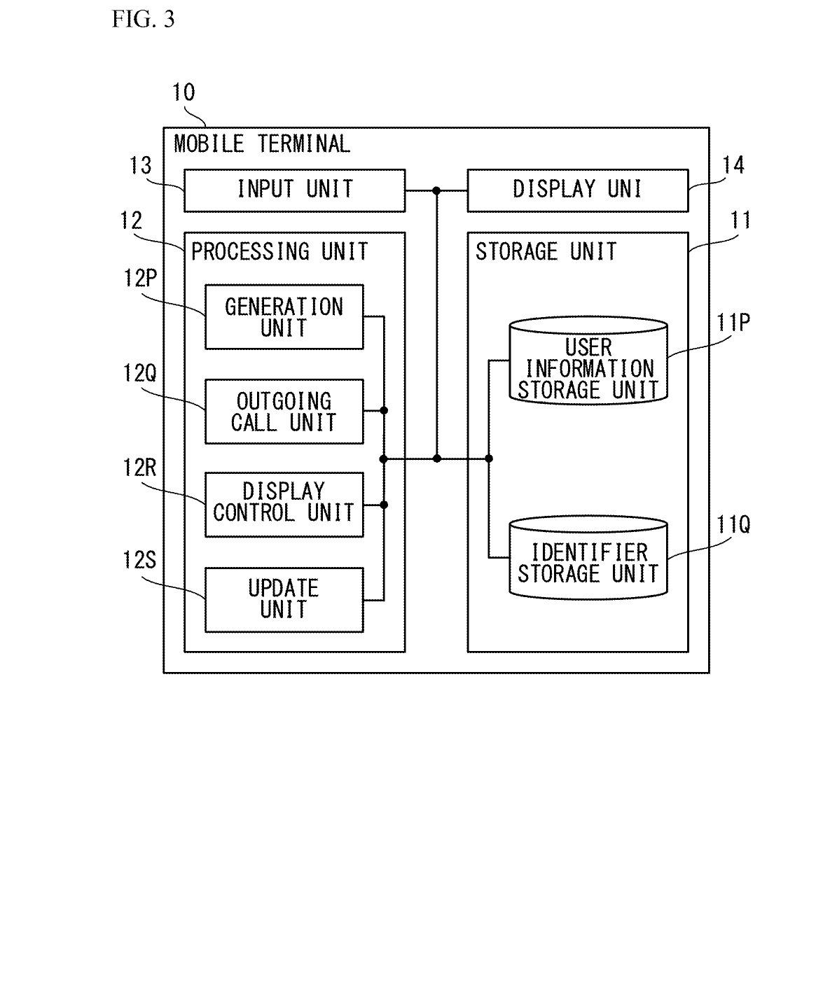

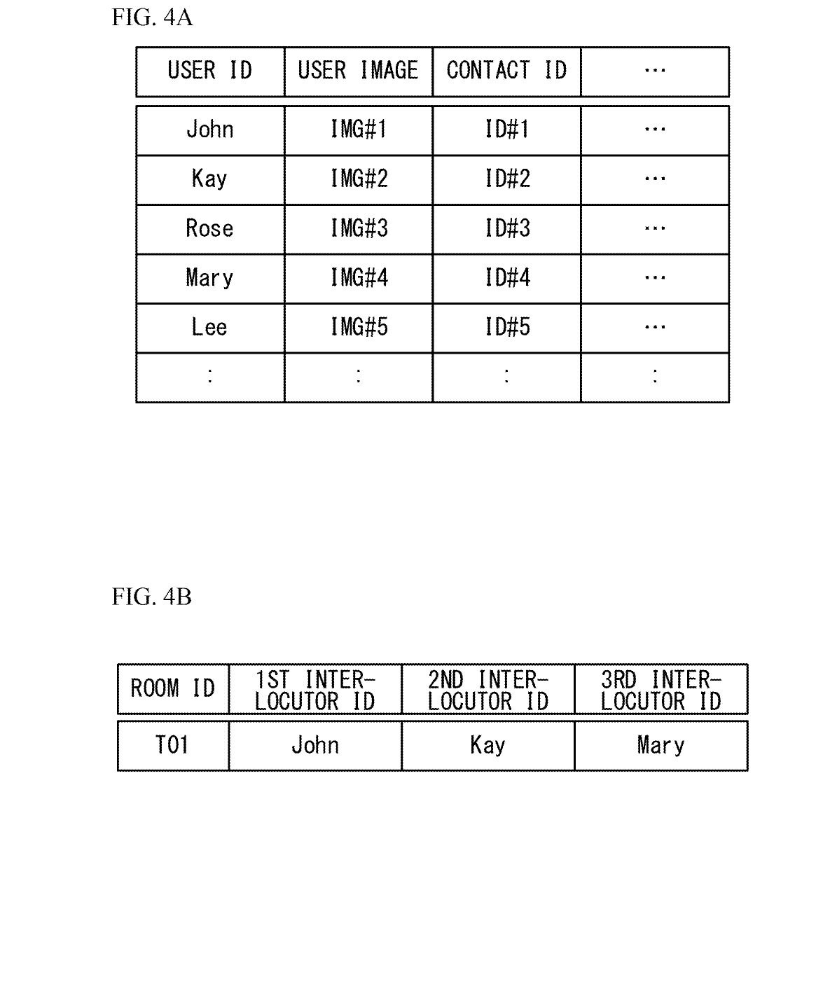

The functional configuration of the mobile terminal 10 will be described with reference to FIGS. 3, 4A, and 4B. Note that FIG. 3 illustrates a main part of the functions of the mobile terminal 10. The functional configuration of the mobile terminal 21, 22, and 23 described above is basically the same as that of the mobile terminal 10, and thus a detailed description thereof will be omitted.

As illustrated in FIG. 3, the mobile terminal 10 includes a storage unit 11, a processing unit 12, an input unit 13, and a display unit 14. The storage unit 11 can be realized by at least one of the RAM 10B, the ROM 10C, and the NVM 10D described above. The processing unit 12 can be realized by the above-described CPU 10A. The input unit 13 can be realized by the camera 10F, the touch panel 10H, and the microphone 10J described above. The display unit 14 can be realized by the display 10I described above. The storage unit 11, the processing unit 12, the input unit 13, and the display unit 14 are connected to each other. The storage unit 11 includes a user information storage unit 11P and an identifier storage unit 11Q. The processing unit 12 includes a generation unit 12P, an outgoing call unit 12Q, a display control unit 12R, and an update unit 12S.

The user information storage unit 11P stores information about the users P1, P2, P3, and the like as user information in advance. The user information may include or exclude information about the user P0. As illustrated in FIG. 4A, the user information includes a plurality of items such as a user identifier (ID), a user image, and a contact ID. Items other than these may be included in the user information as appropriate. In the item of the user ID, user identification information (for example, a name or the like) for identifying the users P1, P2, P3, or the like is registered. In the item of the user image, a setting image (for example, a face image imitating the user himself/herself) set by each of the users P1, P2, and P3 is registered. In the item of the contact ID, contact information (for example, telephone numbers) related to the contacts of the users such as P1, P2, and P3 is registered.

The identifier storage unit 11Q stores talk room identification information. The talk room identification information is information for identifying a virtual talk room in which the group call is performed. As illustrated in FIG. 4B, the talk room identification information includes a plurality of items such as a room ID, a first interlocutor ID, a second interlocutor ID, and a third interlocutor ID. In the item of the room ID, for example, the group call ID “T01” is registered. For example, when the users P1, P2, and P3 are designated as the conversation partners of the group call, the user IDs of the users P1, P2, and P3 are registered in the items of the first interlocutor ID, the second interlocutor ID, and the third interlocutor ID, as illustrated in FIG. 4B. The identifiers of the group call may be a combination of the user IDs of the users P1, P2, and P3. This improves the identifiability of the identifier of the group call. The identifier of the group call may be combination of the date and time when the group generation is instructed, which will be described later, and the user IDs of the users P1, P2, and P3. This further improves the identifiability of the identifier of the group call.

The generation unit 12P generates the identifier of the group call when the mobile terminal 10 of the user P0 is instructed to generate a group in which the users P1, P2, and P3 are designated. The generation unit 12P may generate the identifier of the group call as described above. When the generation unit 12P generates the identifier of the group call, the generation unit 12P generates the talk room identification information in which the identifier of the group call is associated with the user IDs of the conversation partners of the group call, and stores the generated talk room identification information in the identifier storage unit 11Q. Thus, the identifier storage unit 11Q stores the talk room identification information (see FIG. 4B). When the start of the group call is instructed, the generation unit 12P notifies the call control system 100 of the identifier of the group call. At this time, the generation unit 12P associates the user ID “John” of the designated user P1, the user ID “Kay” of the user P2, and the like with the identifier of the group call, and notifies the identifier of the group call. The generation unit 12P may notify the talk room identification information stored in the identifier storage unit 11Q.

When the generation unit 12P notifies the call control system 100 of the group call ID or the talk room identification information, the outgoing call unit 12Q transmits the group call ID and a calling signal of the user P1 to the mobile terminal 21 of the user P1 designated first.

When the participation of the user P1 in the group call is notified from the call control system 100, the outgoing call unit 12Q transmits the identifier of the group call and the calling signal of the user P2 to the mobile terminal 22 of the user P2. When the participation of the user P2 in the group call is notified from the call control system 100, the outgoing call unit 12Q transmits the identifier of the group call and the calling signal of the user P3 to the mobile terminal 22 of the user P3.

When the participation of the user P1 in the group call is notified from the call control system 100, the display control unit 12R displays a call screen of the group call on the display unit 14 of the mobile terminal 10. The update unit 12S updates the call screen of the group call when the participation of the user P2 in the group call is notified from the call control system 100. Further, the update unit 12S updates the call screen of the group call when the participation of the user P3 in the group call is notified from the call control system 100. The update unit 12S may update the call screen of the group call at each unit time.

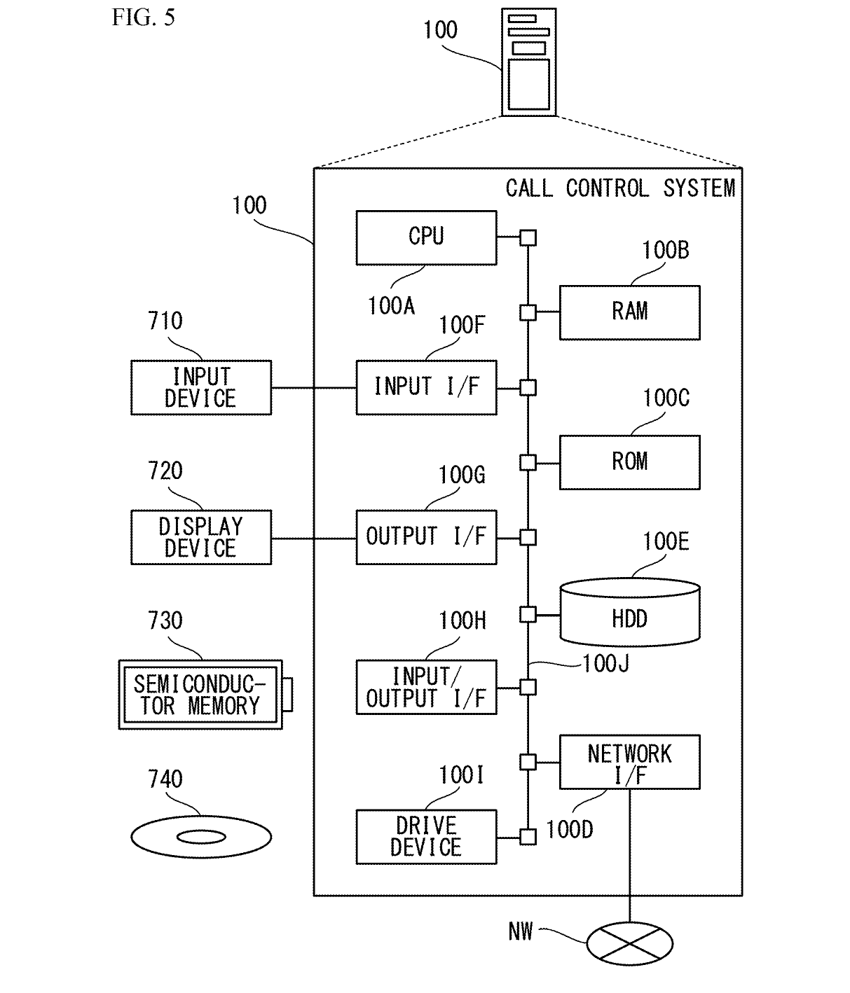

Next, a hardware configuration of the call control system 100 will be described with reference to FIG. 5.

As illustrated in FIG. 5, the call control system 100 includes a CPU 100A as a processor, a RAM 100B and a ROM 100C as memories, and a network interface (I/F) 100D. The call control system 100 may include at least one of a hard disk drive (HDD) 100E, an input I/F 100F, an output I/F100G, an input and output I/F 100H, and a drive device 100I as necessary. The components from the CPU 100A to the drive device 100I are connected to each other by an internal bus 100J. The computer can be realized by cooperation of at least the CPU 100A and the RAM 100B.

An input device 710 is connected to the input I/F 100F. The input device 710 includes, for example, a keyboard and a mouse. A display device 720 is connected to the outputs I/F100G. The display device 720 is, for example, a liquid crystal display. A semiconductor memory 730 is connected to the input and output I/F 100H. The semiconductor memory 730 may be, for example, a universal serial bus (USB) memory or a flash memory. The input and output I/F 100H reads a call management program stored in the semiconductor memory 730. The input I/F 100F and the input and output I/F 100H include, for example, USB ports. The output I/F100G includes, for example, a display port.

A portable recording medium 740 is inserted into the drive device 100I. The portable recording medium 740 may be a removable disk such as a compact disc (CD) - ROM or a digital versatile disc (DVD). The drive device 100I reads the call management program recorded in the portable recording medium 740. The network I/F 100D includes, for example, a LAN port. The network I/F 100D is connected to the wired communication network NW described above.

The call management program stored in the ROM 100C or the HDD 100E is stored in the above-described RAM 100B by the CPU 100A. In the RAM 100B, the call management program recorded in the portable recording medium 740 is stored by the CPU 100A. The CPU 100A executes the stored call management program, so that the call control system 100 realizes various functions described later and executes various processes described later. The call management program may be a program according to a processing sequence diagram described later.

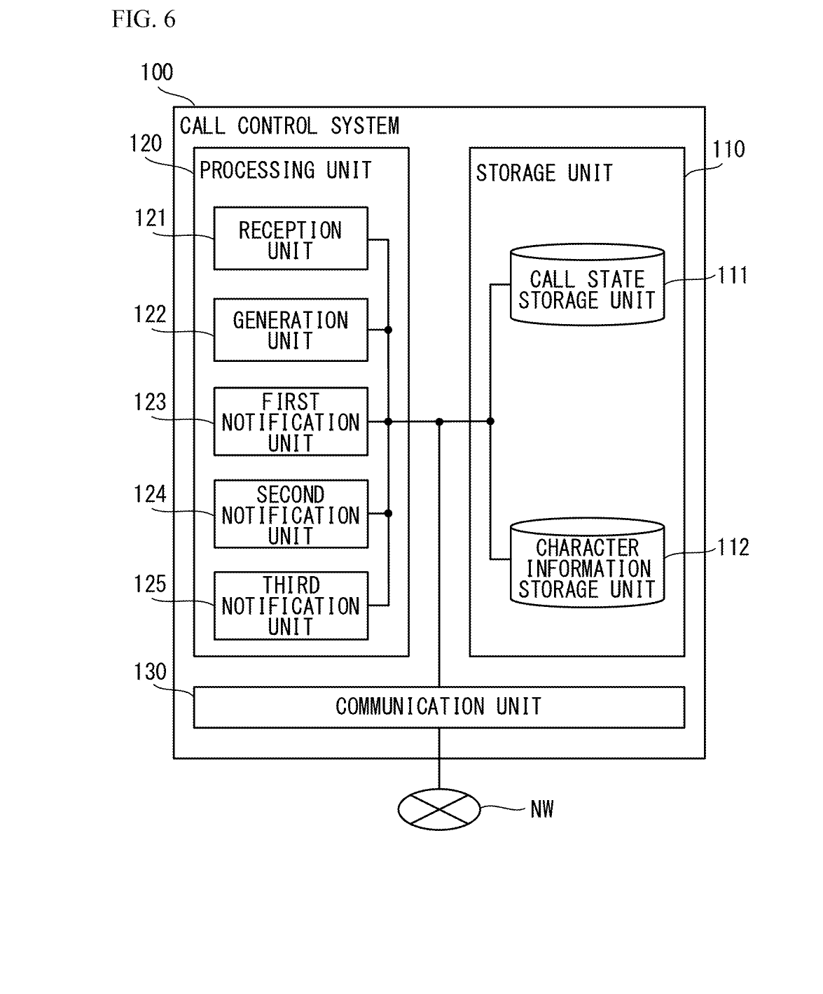

The functional configuration of the call control system 100 will be described with reference to FIGS. 6 to 8. Note that FIG. 6 illustrates a main part of the functions of the call control system 100.

As illustrated in FIG. 6, the call control system 100 includes a storage unit 110, a processing unit 120, and a communication unit 130. The storage unit 110 can be realized by one or both of the RAM 100B and the HDD 100E described above. The processing unit 120 can be realized by the above-described CPU 100A. The communication unit 130 can be realized by the network I/F 100D described above. Therefore, the storage unit 110, the processing unit 120, and the communication unit 130 are connected to each other. The storage unit 110 includes a call state storage unit 111 and a character information storage unit 112. The processing unit 120 includes a reception unit 121, a generation unit 122, a first notification unit 123, a second notification unit 124, and a third notification unit 125.

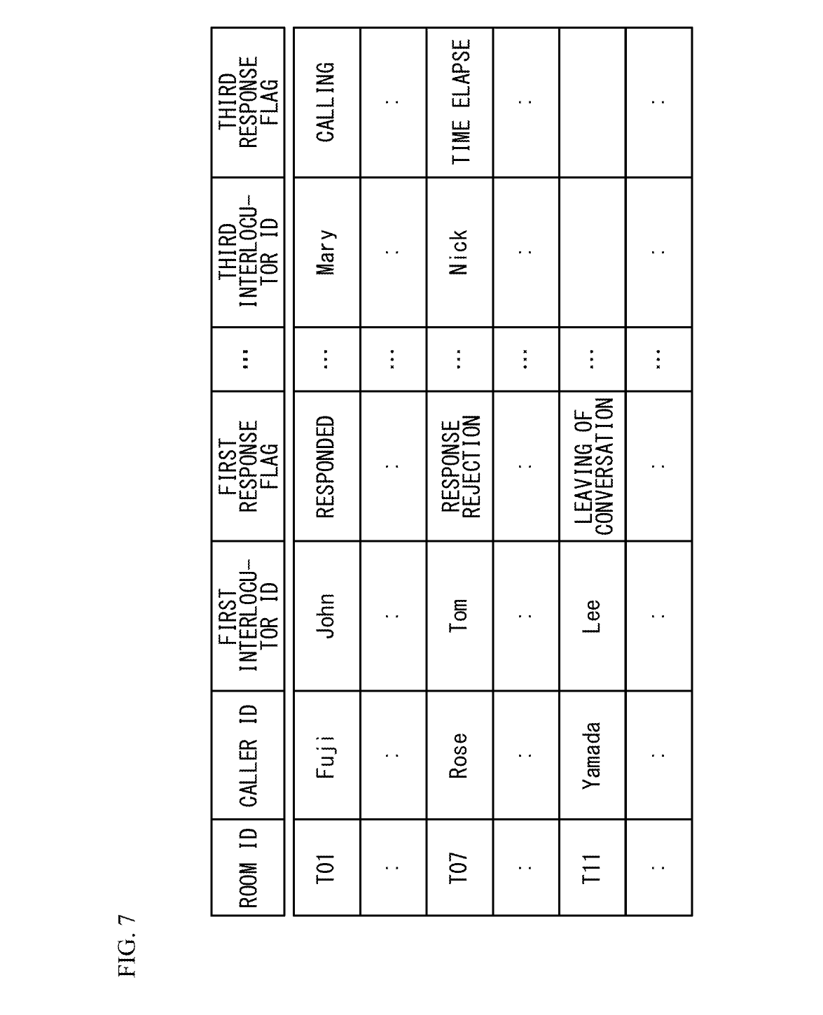

The call state storage unit 111 stores call state information for managing the call state of the group call. As illustrated in FIG. 7, the call state information includes a plurality of items such as a room ID, a caller ID, a first interlocutor ID, a first response flag, … , a third interlocutor ID, and a third response flag. In FIG. 7, the item of the second interlocutor ID and the item of the second response flag are not illustrated. In the item of the room ID, the identifier of the group call is registered. In the item of the caller ID, the user ID of a caller of the group call is registered.

The user ID of the first conversation partner in the group call is registered in the item of the first conversation partner ID. Since the items of the second interlocutor ID and the third interlocutor ID are basically the same as the items of the first interlocutor ID, detailed description thereof will be omitted. The response state of the first conversation partner is registered in the item of the first response flag. The items of the second response flag and the third response flag are basically the same as the items of the first response flag, and thus detailed description thereof will be omitted.

The response state includes, for example, “responded”, “response rejection”, “leaving of conversation”, “calling”, “time elapse”, and the like. The “responded” indicates a state in which a response button is pressed on the incoming call screen described later. The response rejection indicates a state where a rejection button is pressed on the incoming call screen. The “leaving of conversation” indicates a state of leaving the group call. The “calling” indicates a state from the start of the incoming call of the call signal to the depression of either the response button or the rejection button on the incoming call screen. The “time elapse” indicates a state in which a certain time has elapsed without pressing any of the response button and the rejection button from the start of the incoming call of the call signal on the incoming call screen. The certain time is, for example, several tens of seconds, and is set in advance.

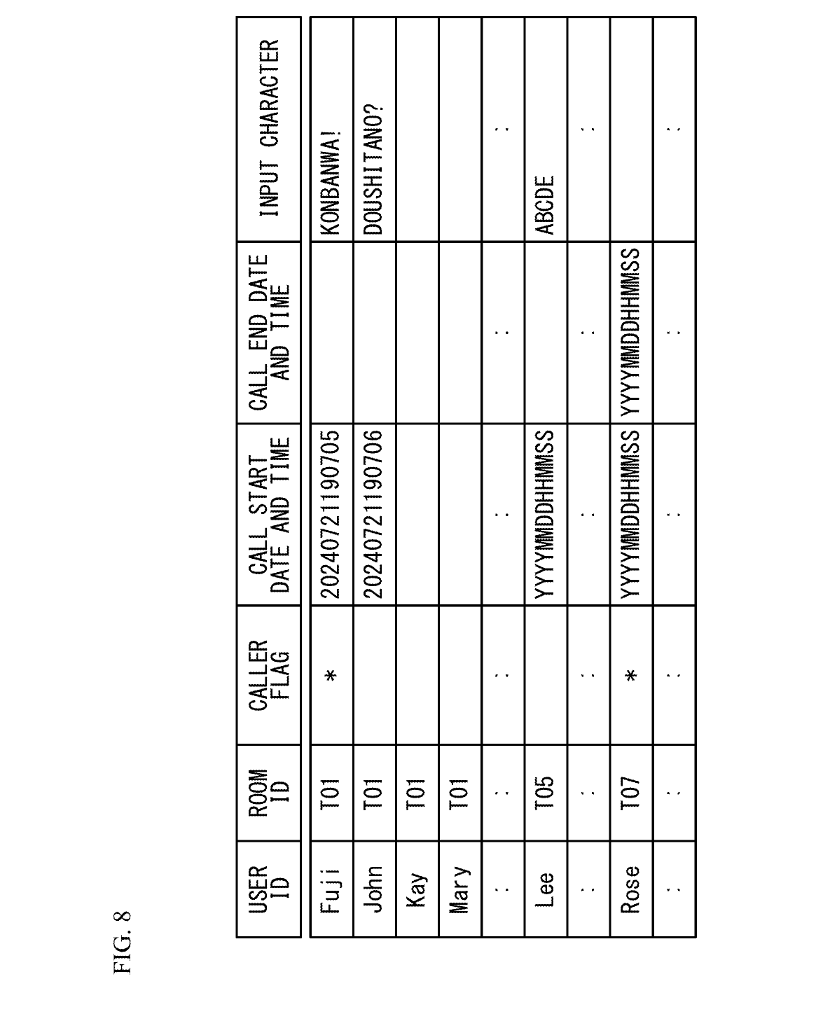

The character information storage unit 112 stores character information. The character information includes characters input by the users P0, P1, P2, and P3. Specifically, as illustrated in FIG. 8, the character information includes a plurality of items such as a user ID, a room ID, a caller flag, a call start date and time, a call end date and time, and an input character.

The user ID is registered in the item of the user ID. In the item of the room ID, the identifier of the group call is registered. In the present embodiment, as an example, the group call is performed by four users P0, P1, P2, and P3, and thus a common room ID “T01” is registered in the item of the room ID.

In the item of the caller flag, a symbol for identifying a caller who has performed an operation for calling a conversation partner of the group call is registered. In the present embodiment, since the user P0 performs an operation of calling the users P1, P2, and P3 who are conversation partners, a symbol “*” is registered in the caller flag of the user P0. The date and time when the group call is started is registered in the item of the call start date and time. In the case of the caller, the date and time when the operation of calling the conversation partner is performed is registered in the item of the call start date and time. In the case of the conversation partner, the date and time when the operation of responding to the call is performed is registered in the item of the call start date and time. The date and time when the group call is ended is registered in the item of the call end date and time. In the case of the caller, the date and time when the call screen is closed is registered in the item of the call end date and time. In the case of the conversation partner, the date and time when the call screen is closed or the user is left from the group call is registered in the item of the call end date and time.

The item of the input character is filled with characters entered in an input region provided on the call screen. Therefore, when the user P0 who is the caller inputs a character in the input region, the character input in the input region is registered in the item of the input character of the user P0. When the user P1, who is the conversation partner of the caller, inputs a character in the input region, the character input in the input region is registered in the item of the input character of the user P1. The outgoing call unit 12Q of the mobile terminal 10 can transmit the characters input in the input region to the call control system 100. The reception unit 121 of the call control system 100 can receive the character transmitted from the mobile terminal 10 and update the character information.

The reception unit 121 receives the identifier of the group call notified from the mobile terminal 10. The generation unit 122 generates the call state information for managing the call state of the group call based on the identifier of the group call received by the reception unit 121. When the generation unit 122 generates the call state information, the generation unit 122 stores the call state information in the call state storage unit 111. Thus, the call state storage unit 111 stores the call state information (see FIG. 7).

When the participation of the user P1 in the group call is notified from the mobile terminal 21, the first notification unit 123 notifies the mobile terminal 10 of the participation of the user P1 in the group call via the communication unit 130. When the participation of the user P1 in the group call is notified, the first notification unit 123 can update the call state storage unit 111 and the character information storage unit 112. For example, the first notification unit 123 can update the first response flag, the call start date and time, and the like.

The mobile terminal 21 can notify the call control system 100 of the participation of the user P1 in the group call based on the incoming call of the mobile terminal 21 in response to the identifier of the group call and the calling signal of the user P1 transmitted from the mobile terminal 10, and the response operation of the user P1 in response to the incoming call screen displayed based on the incoming call of the mobile terminal 21.

When the participation of the user P2 in the group call is notified from the mobile terminal 22, the second notification unit 124 notifies the mobile terminal 10 of the participation in the group call of the user P2 via the communication unit 130. When the participation in the group call of the user P2 is notified, the second notification unit 124 can update the call state storage unit 111 and the character information storage unit 112. For example, the second notification unit 124 can update the second response flag, the call start date and time, and the like.

The mobile terminal 22 can notify the call control system 100 of the participation of the user P2 in the group call based on the incoming call of the mobile terminal 22 in response to the identifier of the group call and the calling signal of the user P2 transmitted from the mobile terminal 10 and the response operation of the user P2 in response to the incoming call screen displayed based on the incoming call of the mobile terminal 22.

When the participation of the user P3 in the group call is notified from the mobile terminal 23, the third notification unit 125 notifies the mobile terminal 10 of the participation of the user P3 in the group call via the communication unit 130. The third notification unit 125 can update the call state storage unit 111 and the character information storage unit 112 when the participation of the user P3 in the group call is notified. For example, the third notification unit 125 can update the third response flag, the call start date and time, and the like.

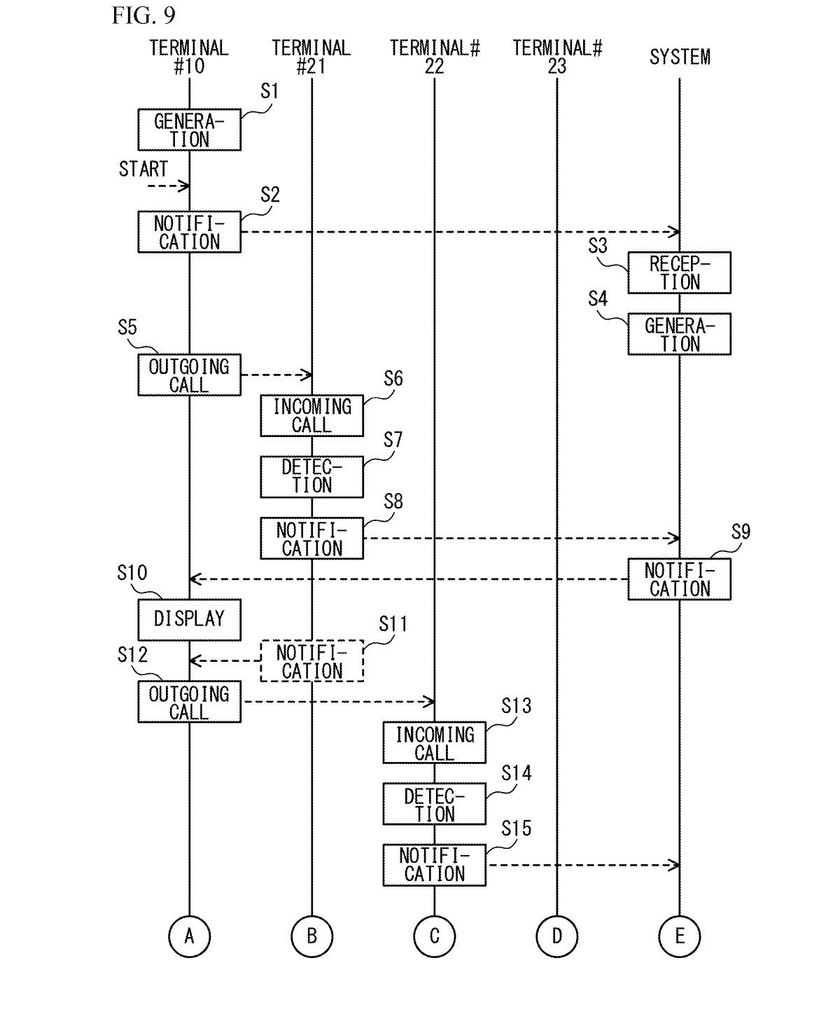

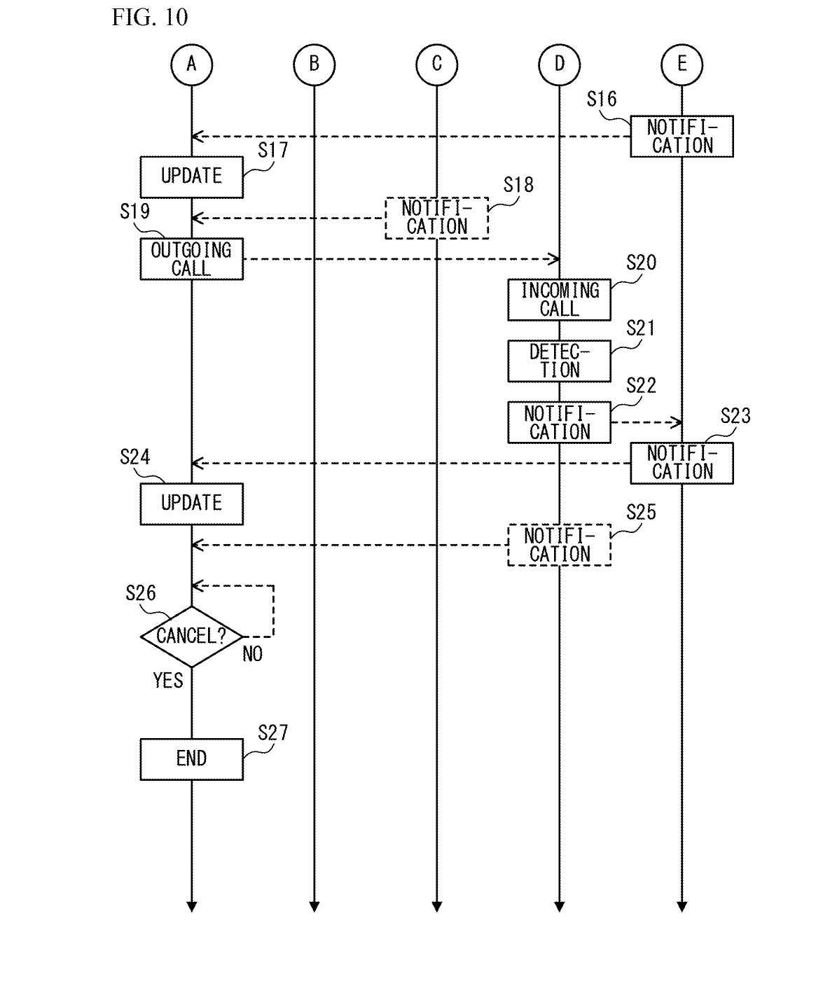

The operations of the mobile terminals 10, 21, 22, and 23 and the call control system 100 will be described with reference to FIGS. 9 to 14. FIGS. 9 and 10 are continuous. In FIG. 9, a terminal #10 corresponds to the mobile terminal 10. A terminal #21 corresponds to the mobile terminal 21. A terminal #22 corresponds to the mobile terminal 22. A terminal #23 corresponds to the mobile terminal 23. The system corresponds to the call control system 100.

First, as illustrated in FIG. 9, the generation unit 12P of the mobile terminal 10 generates the identifier of the group call (step S1). For example, when the mobile terminal 10 is instructed to generate a group by designating the users P1, P2, and P3, the generation unit 12P generates the identifier of the group call as described above. When the mobile terminal 10 is instructed to start the group call after the generation of the identifier of the group call, the generation unit 12P detects the start of the group call and notifies the call control system 100 of the identifier of the group call (step S2).

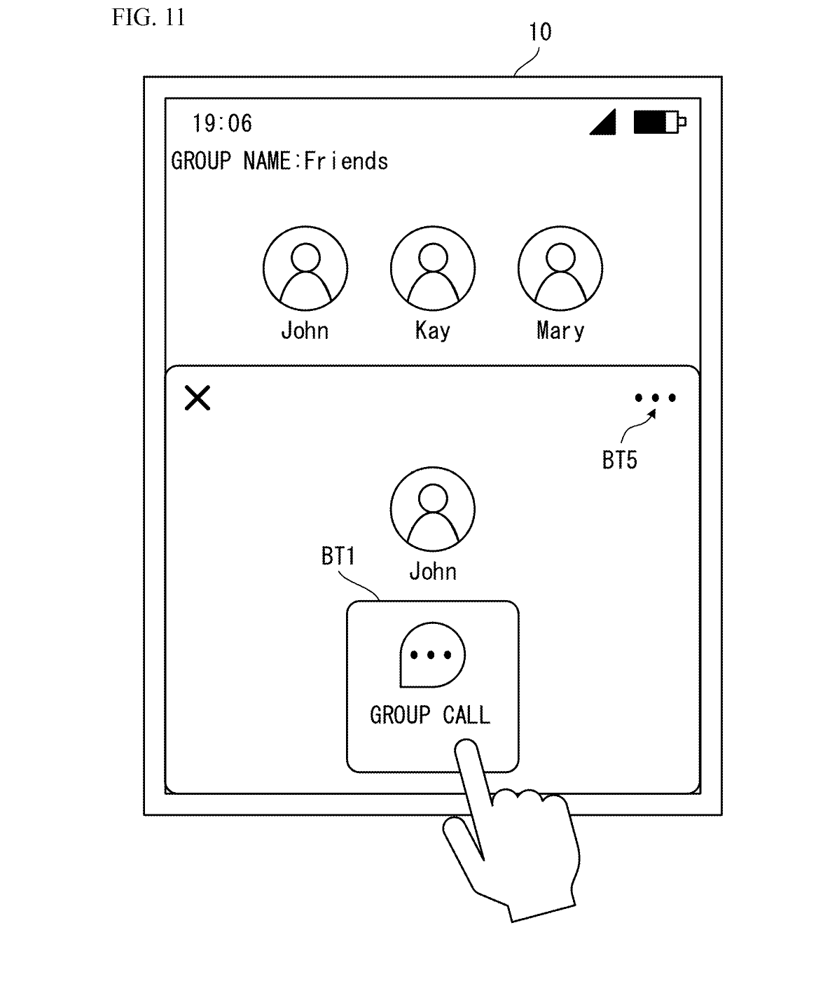

For example, as illustrated in FIG. 11, a group name “Friends” is included in the start screen of the group call. In the group name “Friends”, the user P0 to which a user ID “John” is assigned, the user P1 to which a user ID “Kay” is assigned, and the user P2 to which a user ID “Mary” is assigned are stored by the previous designation of the user P3. The user P0 may start the group call by individually designating the users P1, P2, and P3 without designating a target group of such the group call in advance.

When a start button BT1 of the group call is pressed by a finger of the user P0 on the start screen of the group call, the generation unit 12P detects the start of the group call and notifies the identifiers of the group call. When a selection button BT5 of the call scheme of the group call is pressed by the finger of the user P0, the generation unit 12P displays a screen for requesting the user P0 to select the call scheme on the display unit 14 of the mobile terminal 10. The call system selectively includes a first call scheme for making a call by characters and a second call scheme for making a call by voice. The user P0 may select one of the first call scheme and the second call scheme. When the user P0 selects either the first call scheme or the second call scheme, the generation unit 12P detects the start of the group call designating the users P1, P2, P3 and the selected call scheme, and notifies the identifier of the group call. The generation unit 12P may notify the selected call scheme together with the identifier of the group call.

The reception unit 121 of the call control system 100 receives the identifier of the group call notified from the mobile terminal 10 (step S3). When the reception unit 121 receives the identifier of the group call, the generation unit 122 generates the call state information (step S4).

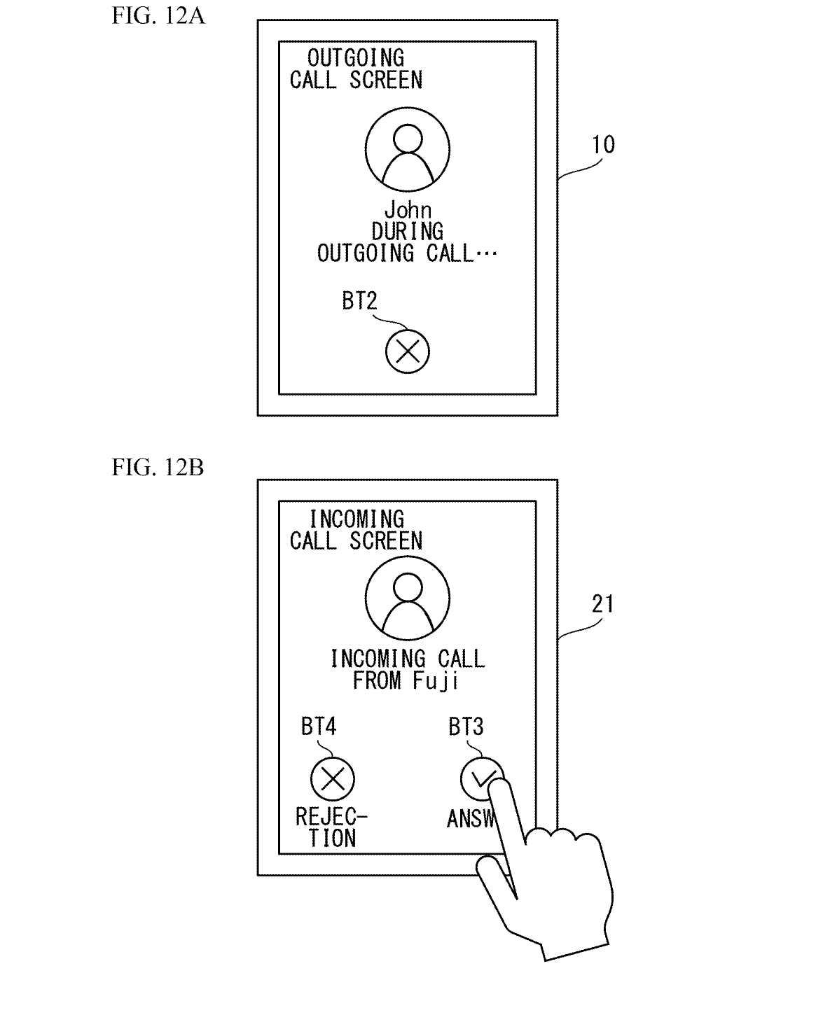

After notifying the call control system 100 of the identifier of the group call, the outgoing call unit 12Q of the mobile terminal 10 transmits the identifier of the group call and the calling signal of the user P1 (step S5). More specifically, the outgoing call unit 12Q transmits the identifier of the group call and the calling signal of the user P1 to the mobile terminal 21 of the user P1 designated first as one of the conversation partners of the group call. The outgoing call unit 12Q switches the start screen of the group call to the outgoing call screen of the group call as illustrated in FIG. 12A immediately before or immediately after the identifier of the group call and the calling signal of the user P1 are transmitted. The outgoing call screen includes a user ID and a face image of the conversation partner, and a cancel button BT2 for canceling the call. When the user P0 presses the cancel button BT2, the outgoing call unit 12Q cancels the call and switches the outgoing call screen to the start screen of the group call.

When the identifier of the group call and the calling signal of the user P1 are transmitted from the mobile terminal 10, the identifier of the group call and the calling signal arrive at the mobile terminal 21 (step S6). The display control unit displays a first incoming call screen on the display unit based on the identifier of the group call and the incoming call of the call signal. As illustrated in FIG. 12B, the first incoming call screen includes a response button BT3 for responding to the incoming call and a rejection button BT4 for rejecting the incoming call, in addition to the user ID and the face image of the caller. In FIG. 12B, the response button BT3 includes a symbol such as a check mark, but this symbol may be changed to characters such as “answer the phone” or “OK” as appropriate, or this symbol may be changed to a picture of a receiver as appropriate.

When the response operation of pressing the response button BT3 is performed by the finger of the user P1, the display control unit of the mobile terminal 21 detects a response to the incoming call (step S7), and notifies the call control system 100 of the participation of the user P1 in the group call (step S8). When the user P1 performs a rejection operation of pressing the rejection button BT4 with the finger, the display control unit of the mobile terminal 21 detects whether to permit a response to the incoming call. In this case, the display control unit of the mobile terminal 21 may skip the process of step S8 and execute the process of step S11 described later. In this case, the display control unit of the mobile terminal 21 may switch the incoming call screen to another screen. The another screen is, for example, a screen displayed immediately before the first incoming call screen.

When the participation of the user P1in the group call is notified from the mobile terminal 21 to the call control system 100, the first notification unit 123 of the call control system 100 notifies the mobile terminal 10 of the participation of the user P1 in the group call (step S9). When the participation of the user P1 in the group call is notified from the call control system 100, the display control unit 12R of the mobile terminal 10 displays a call screen of the group call on the display unit 14 of the mobile terminal 10 (step S10).

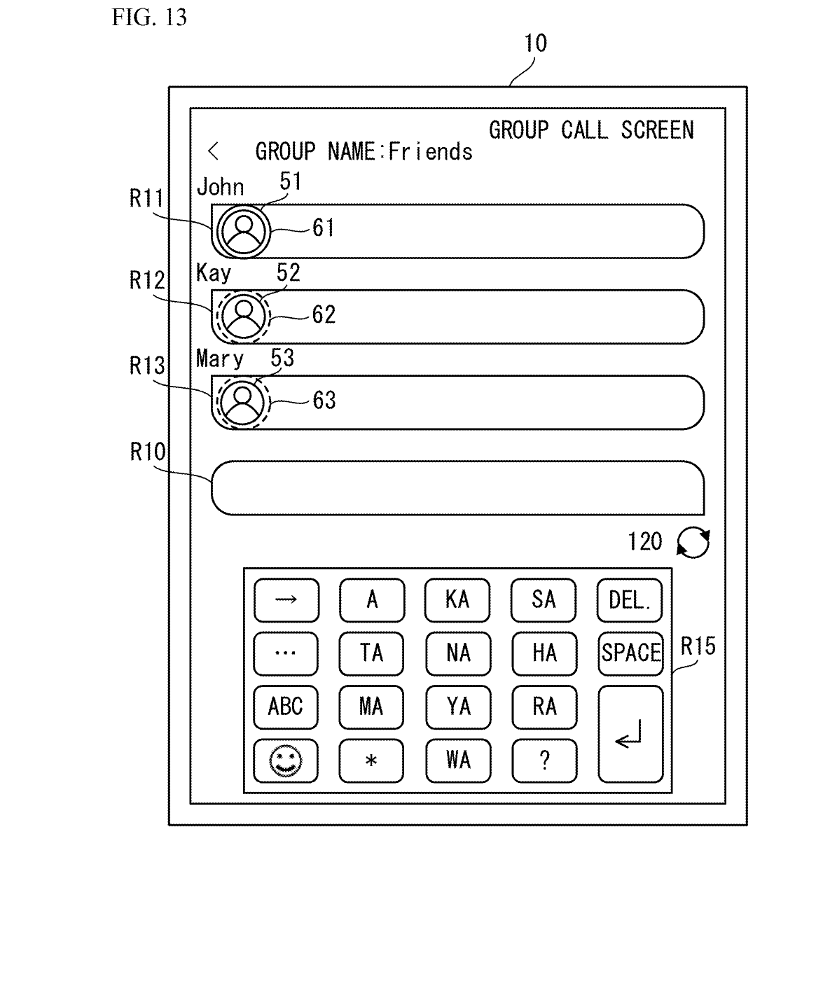

As illustrated in FIG. 13, the call screen of the group call includes an input region P0 where the user P1 inputs characters, and a plurality of display regions R11, R12, and R13 for displaying characters input by the users P1, P2, and P3 as the conversation partners. The display regions R11, R12, and R13 are divided for each conversation partner. The color inside the input region R10 and the colors inside the display regions R11, R12, and R13 may be the same or different. The call screen of the group call includes a character input unit R15 for inputting characters in the input region R10. The user P0 can input the character in the input region R10 by performing an operation of pressing any character in the character input unit R15.

Here, setting images 51, 52, and 53 set by the users P1, P2, and P3 are arranged in the display regions R11, R12, and R13, respectively. Accordingly, the user P0 can instantly understand which of the users P1, P2, and P3 has input the character, not only by the user ID but also by the setting image 51, 52, and 53. Outer peripheral frames 61, 62, and 63 are arranged on the outer peripheries of the setting images 51, 52, and 53. The update unit 12S can change the colors of the outer peripheral frames 61, 62, and 63 according to the response state to the group call.

For example, when the response state of the user P1 has transitioned from the “responded” to “leaving of conversation”, the update unit 12S changes a first color of the outer peripheral frame 63 to a second color. That is, the first color corresponds to a color indicating the “responded”, and is indicated by a solid line in FIG. 13. The second color corresponds to a color representing a state other than the “responded”, and is indicated by a broken line in FIG. 13. In this manner, the update unit 12S can partially change the colors of the display regions R11, R12, and R13 according to the response state to the group call. The update unit 12S may change the color of the display regions R11, R12, and R13 as a whole according to the response state to the group call. For example, the update unit 12S may change the background colors inside the display regions R11, R12, and R13.

When the participation of the user P1 in the group call is notified, the display control unit 12R can display the call screen of the group call on the mobile terminal 10. On the other hand, as illustrated in FIG. 9, when the participation of the user P1 in the group call is not notified, the display control unit 12R cannot display the call screen of the group call, and the subsequent outgoing call processing may be interrupted.

Therefore, when the response operation of pressing the response button P1 by the finger of the user BT3 is not performed for a certain period of time, the display control unit of the mobile terminal 21 notifies the mobile terminal 10 of the elapse of the time limit as illustrated in FIG. 9 (step S11). That is, when a certain time has elapsed without pressing any of the response button BT3 and the rejection button BT4 from the start of the incoming call of the calling signal on the incoming call screen, the display control unit of the mobile terminal 21 notifies the elapse of the time limit. The elapse of the time limit consequently corresponds to non-participation in the group call.

Therefore, the display control unit 12R transmits the identifier and the calling signal of the user P2 to the mobile terminal 22 even when the participation in the group call is notified or even when the elapse of the time limit is notified (step S12). As described above, the display control unit 12R may display the call screen of the group call and execute the outgoing call process, or may execute the outgoing call process without displaying the call screen of the group call. Therefore, the display control unit 12R can avoid interruption of the outgoing call processing, and can start the smooth group call. As a result, the realization of the group call is promoted. The process of step S12 may be executed at the same timing as the process of step S10.

When the identifier of the group call and the calling signal of the user P2 are transmitted from the mobile terminal 10, the identifier of the group call and the calling signal are received by the mobile terminal 22 (step S13). The display control unit of the mobile terminal 22 displays a second incoming call screen on the display unit based on the identifier of the group call and the incoming call of the call signal. The second incoming call screen is basically the same as a first incoming call screen, and thus detailed description thereof will be omitted.

When the response operation of pressing the response button is performed by the finger of the user P2, the display control unit of the mobile terminal 22 detects a response to the incoming call (step S14), and notifies the call control system 100 of the participation of the user P2 in the group call (step S15). When the user P2 performs the rejection operation of pressing the rejection button with the finger, the display control unit of the mobile terminal 22 detects whether to permit a response to the incoming call. In this case, the display control unit of the mobile terminal 22 may skip the process of step S15 and execute the process of step S18 as illustrated in FIG. 10. In this case, the display control unit of the mobile terminal 22 may switch the incoming call screen to another screen, similarly to the mobile terminal 21.

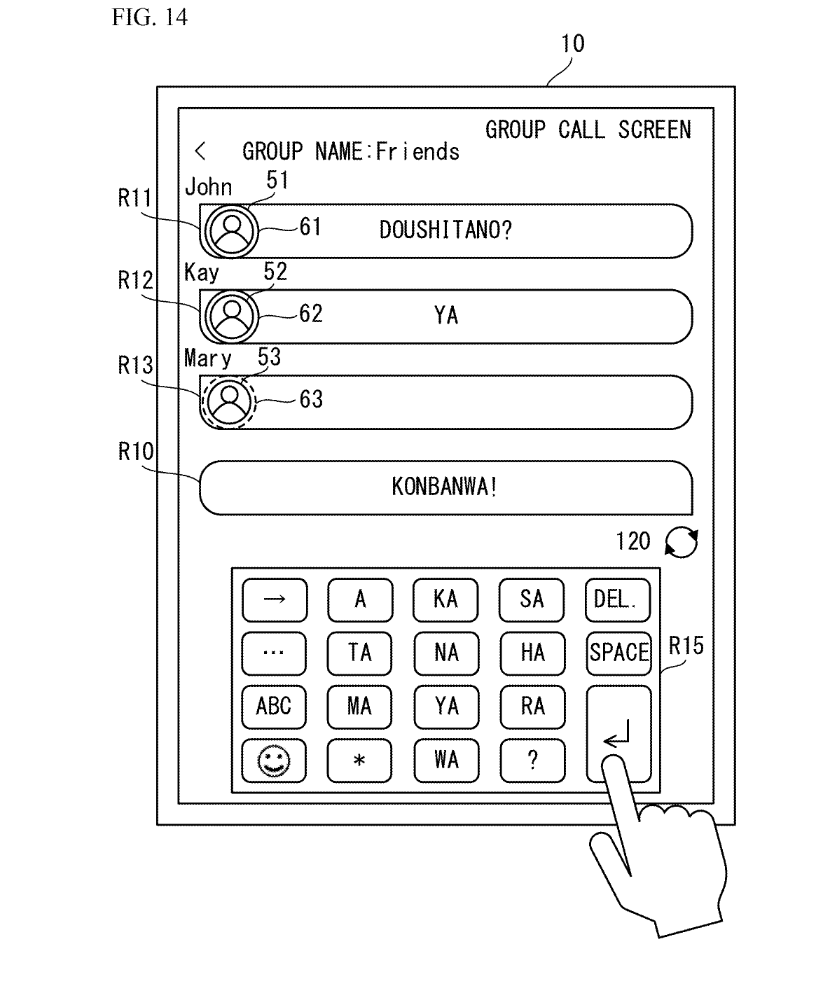

When the participation of the user P2 in the group call is notified from the mobile terminal 22 to the call control system 100, the second notification unit 124 of the call control system 100 notifies the mobile terminal 10 of the participation of the user P2 in the group call (step S16). When the participation of the user P2 in the group call is notified from the call control system 100, the update unit 12S of the mobile terminal 10 updates the call screen of the group call (step S17). For example, as illustrated in FIG. 14, when the response state of the user P2 is changed from the calling state to the responded state, the update unit 12S changes the color of the outer peripheral frame 62. In particular, the update unit 12S changes from the second color to the first color. Accordingly, the user P0 may recognize the response state of the user P2 with respect to the group call. As described above, the update unit 12S may change the color of the display regions R11, R12, and R13 as a whole according to the response state to the group call.

When the response operation of pressing the response button by the finger of the user P2 is not performed for a certain period of time, the display control unit of the mobile terminal 22 notifies the mobile terminal 10 of the elapse of the time limit as illustrated in FIG. 10 (step S18). That is, the display control unit of the mobile terminal 22 notifies the mobile terminal 10 of the elapse of the time limit, similarly to the mobile terminal 21. Accordingly, the display control unit 12R transmits the identifier and the calling signal of the user P3 to the mobile terminal 23, regardless of whether the participation in the group call is notified or the non-participation in the group call is notified (step S19).

When the identifier of the group call and the calling signal of the user P3 is transmitted from the mobile terminal 10, the identifier of the group call and the calling signal are received by the mobile terminal 23 (step S20). The display control unit of the mobile terminal 23 displays a third incoming call screen on the display unit based on the identifier of the group call and the incoming call of the call signal. The third incoming call screen is basically the same as the first incoming call screen, and thus detailed description thereof will be omitted.

When the response operation of pressing the response button is performed by the hand of the user P3, the display control unit of the mobile terminal 23 detects a response to the incoming call (step S21), and notifies the call control system 100 of the participation of the user P3 in the group call (step S22). When the user P3 performs the rejection operation of pressing the rejection button with the finger, the display control unit of the mobile terminal 23 detects whether to permit the response to the incoming call. In this case, the display control unit of the mobile terminal 23 may skip the process of step S22 and execute the process of step S25. In this case, the display control unit of the mobile terminal 22 may switch the incoming call screen to another screen, similarly to the mobile terminal 21.

When the participation of the user P3 in the group call is notified from the mobile terminal 23 to the call control system 100, the third notification unit 125 of the call control system 100 notifies the mobile terminal 10 of the participation of the user P3 in the group call (step S23). When the participation of the user P3 in the group call is notified from the call control system 100, the update unit 12S of the mobile terminal 10 updates the call screen of the group call (step S24). For example, as illustrated in FIG. 14, when the response state of the user P3 is changed from the calling state to the responded state, the update unit 12S changes the color of the outer peripheral frame 63. Accordingly, the user P0 may recognize the response state of the user P3 with respect to the group call.

When the response operation of pressing the response button by the finger of the user P3 is not performed for a certain period of time, the display control unit of the mobile terminal 23 notifies the mobile terminal 10 of the elapse of the time limit (step S25). Accordingly, the display control unit 12R maintains the display of the call screen of the group call until the display control unit S26 detects the cancellation of the group call (step S26: NO). Therefore, the update unit 12S can acquire the characters input by each of the users P1, P2, and P3, who are the conversation partners of the group call, from the call control system 100 for each unit time, and update the display regions R11, R12, and R13. The unit time may be a unit of several minutes such as 120 seconds, or may be a unit of several tens of seconds.

Here, for example, when the user P0 performs an operation of closing the call screen of the group call, the display control unit 12R detects the cancellation of the group call (step S26: YES), and executes the end process of the group call (step S27). For example, the display control unit 12R can execute an end process of disconnecting the communication between the mobile terminal 10 and the mobile terminals 21, 22, and 23 and returning the call screen of the group call to the start screen of the group call.

As described above, according to the present embodiment, the mobile terminal 10 of the user P0 can perform the group call in which the users P1, P2, and P3 are designated. In this case, when the user P1 responds to the incoming call, the mobile terminal 10 dynamically performs the outgoing call to the next user P2 in the background while displaying the call screen of the group call. Then, when the user P2 responds to the incoming call, the mobile terminal 10 dynamically executes the outgoing call to the next user P3 in the background while updating the call screen of the group call. This enables the group call to be started smoothly.

In particular, even if the user P1 does not respond to the incoming call, the mobile terminal 10 dynamically performs the outgoing call to the next user P2 when a certain time elapses. Similarly, even if the user P2 does not respond to the incoming call, the mobile terminal 10 dynamically executes the outgoing call to the next user P3 when a certain time elapses. This also enables the group call to be started smoothly.

In addition, even if any of the users P1, P2, and P3 leaves from the group call, the user P0 can maintain the group call with the remained users P1, P2, or P3 other than a leaving person while instantaneously understanding the leaving by the partial color change of the call screen of the group call. Furthermore, in the group call by characters, since the response operation to the incoming call screen occurs, the user P0 can instantaneously understand the reaction of the users P1, P2, and P3. As a result, when the group call is a call by characters between the user P0 and the users P1, P2, and P3, the real-time property of the group call is improved.

Although the preferred embodiments of the present invention have been described in detail above, the present invention is not limited to the specific embodiments, and various modifications and changes can be made within the scope of the gist of the present invention described in the claims. For example, in the above-described embodiment, three mobile terminals 21, 22, and 23 are described as an example, but any two mobile terminals may be used.

What is claimed is:

1. A call control method executed by a computer of an operation terminal to execute a process, the process comprising :
generating an identifier of a group call when the operation terminal of a user who has a conversation with a plurality of conversation partners is instructed to generate a group in which the plurality of conversation partners are designated;
notifying a management server of the group call of the identifier when start of the group call is instructed;
transmitting the identifier and a first call of a first conversation partner to a first terminal of the first conversation partner belonging to the plurality of conversation partners;
displaying a call screen of the group call on the operation terminal and transmitting the identifier and a second call of a second conversation partner to a second terminal of the second conversation partner belonging to the plurality of conversation partners when participation of the first conversation partner in the group call by a response operation of the first conversation partner to a first incoming call screen displayed on the first terminal based on incoming call of the identifier and the first call is notified from the management server; and
updating the call screen when participation of the second conversation partner in the group call by a response operation of the second conversation partner to a second incoming call screen displayed on the second terminal based on incoming call of the identifier and the second call is notified from the management server.

2. The call control method according to claim 1, the process further comprising:
updating the call screen and transmitting the identifier and a third call of a third conversation partner to a third terminal of a third conversation partner belonging to the plurality of conversation partners; and
further updating the call screen when participation of the third conversation partner in the group call by a response operation of the third conversation partner to a third incoming call screen displayed on the third terminal based on incoming call of the identifier and the third call is notified from the management server.

3. The call control method according to claim 2,
wherein the identifier and the second call are transmitted to the second terminal when elapse of a first time limit for limiting a response operation of the first conversation partner is notified from the first terminal, and
the identifier and the third call are transmitted to the third terminal when elapse of a second time limit for limiting a response operation of the second conversation partner is notified from the second terminal.

4. The call control method according to claim 1,
wherein the call screen includes a plurality of display regions divided for each conversation partner of the plurality of conversation partners, and
the process further includes changing a color of a display region corresponding to any one of the conversation partners when the any one of the conversation partners participating in the group call leaves the group call.

5. The call control method according to claim 1,
wherein the group call is a call by characters between the user and the plurality of conversation partners.

6. The call control method according to claim 1,
wherein the operation terminal selectively uses any one of a first call scheme for making a call by characters and a second call scheme for making a call by voice, during the group call.

7. A non-transitory computer-readable recording medium having stored therein a program for causing a computer to execute a process, the process comprising:
generating an identifier of a group call when an operation terminal of a user who has a conversation with a plurality of conversation partners is instructed to generate a group in which the plurality of conversation partners are designated;
notifying a management server of the group call of the identifier when start of the group call is instructed;
transmitting the identifier and a first call of a first conversation partner to a first terminal of the first conversation partner belonging to the plurality of conversation partners;
displaying a call screen of the group call on the operation terminal and transmitting the identifier and a second call of a second conversation partner to a second terminal of the second conversation partner belonging to the plurality of conversation partners when participation of the first conversation partner in the group call by a response operation of the first conversation partner to a first incoming call screen displayed on the first terminal based on incoming call of the identifier and the first call is notified from the management server; and
updating the call screen when participation of the second conversation partner in the group call by a response operation of the second conversation partner to a second incoming call screen displayed on the second terminal based on incoming call of the identifier and the second call is notified from the management server.

8. A call control system comprising:
a receiver that receives an identifier of a group call from an operation terminal of a user who has a conversation with a plurality of conversation partners when the identifier is notified by an instruction of start of the group call, the identifier being generated by an instruction to the operation terminal of generation of a group in which the plurality of conversation partners are designated;
a generator that generates information for managing the group call based on the identifier;
a first notifier that notifies the operation terminal of participation of a first conversation partner in the group call when the participation of the first conversation partner in the group call is notified from a first terminal of the first conversation partner based on a first incoming call of the first terminal of the first conversation partner to the identifier transmitted from the operation terminal with display of a call screen of the group call in the operation terminal and a first call of the first conversation partner belonging to the plurality of conversation partners, and a response operation of the first conversation partner on a first incoming call screen displayed based on the first incoming call; and
a second notifier that notifies the operation terminal of participation of a second conversation partner in the group call when the participation of the second conversation partner in the group call is notified from a second terminal of the second conversation partner based on a second incoming call of the second terminal of the second conversation partner to the identifier transmitted from the operation terminal with update of the call screen in the operation terminal and a second call of the second conversation partner belonging to the plurality of conversation partners, and a response operation of the second conversation partner on a second incoming call screen displayed based on the second incoming call.
